(19) United States
(12) Patent Application Publication
(10) Pub. No.: US 2010/0318753 A1
(43) Pub. Date: Dec. 16, 2010

(54) MEMORY ARCHITECTURE OF DISPLAY DEVICE AND READING METHOD THEREOF

(75) Inventors: Ching-Wen Lai, Hsinchu (TW); Jung-Ping Yang, Hsinchu County (TW); Yu-Hsun Peng, Cyonglin Township (TW)

Correspondence Address: RABIN & Berdo, PC, 1101 14TH STREET, NW, SUITE 500, WASHINGTON, DC, 20005, US

(73) Assignee: NOVATEK MICROELECTRONICS CORP., Hsinchu (TW)

(21) Appl. No.: 12/634,702

(22) Filed: Dec. 10, 2009

(30) Foreign Application Priority Data
Jun. 15, 2009 (TW) 098119960

(51) Int. Cl. G06F 12/00

(52) U.S. Cl. 711/155; 711/E12.001

(57) ABSTRACT

A memory architecture of a display device including a display data memory block and a processor is provided. The display data memory block includes N sub-memories and N arbiters respectfully coupled to the N sub-memories, wherein N is a positive integer larger than 1. The processor is used for respectfully and continuously outputting corresponding N control signals and N address signals to the N arbiters. After receiving the corresponding control signals, the N arbiters respectfully output the corresponding address signals to corresponding sub-memories, such that the N sub-memories simultaneously access data respectfully according to the N address signals.

This application claims the benefit of Taiwan application Serial No. 98119960, filed Jun. 15, 2009, the subject matter of which is incorporated herein by reference.

### BACKGROUND OF THE INVENTION

1. Field of the Invention

The invention relates in general to a memory architecture of a display device and a reading method thereof, and more particularly to a memory architecture of a high-speed reading display device and a reading method thereof.

2. Description of the Related Art

Referring to FIG. 1 and FIG. 2. FIG. 1 shows a block diagram of a conventional display device. As indicated in FIG. 1, the display device 100 includes a processor 120, a display data memory 140 and a source driving unit 160. The display data memory 140 includes an arbiter 142 and a memory 144. To access data from the memory 144, the processor 120 outputs a writing/reading signal CPU_write/read and a corresponding address signal CPU_add to the arbiter 142. The arbiter 142, according to the writing/reading signal arb_write/read and the address signal CPU_add_arb, controls the memory 144 to write or read pixel data.

To display a frame on the display device 100, the processor 120 outputs a display reading signal LCD_read and a corresponding display address signal LCD_add to the arbiter 142. The arbiter 142, according to the display reading signal LCD_read_arb and the display address signal LCD_add_arb, controls the memory 144 to read display data. The memory 144, according to the write/read enabling signal write/read_en, the display read enabling signal LCD_read_en and the address enabling signal add_en, performs the accessing of pixel data or reads display data and outputs the display data to the processor 120. The processor 120 outputs the display data to the source driving unit 160 for displaying a frame on the display device 100.

As indicated in FIG. 1 and FIG. 2, the display data memory 140 accesses pixel data one item by one item. However, under the high-speed writing mode, when the processor 120 reads display data from the memory 144, the data writing speed may be restricted due to the read time. Also, as the size of the display 100 becomes bigger and bigger, the capacity of the display data memory 140 also becomes greater and greater, and the length of data routing also increases accordingly. As a result, the reading of display data consumes more power due to a heavy load of routing.

### SUMMARY OF THE INVENTION

The invention is directed to a memory architecture of a display device and the reading method thereof. An architecture using multiple arbiters enables memory data to be read at high speed.

According to a first aspect of the present invention, a memory architecture of a display device including a display data memory block and a processor is provided. The display data memory block includes N sub-memories and N arbiters respectfully coupled to the N sub-memories, wherein N is a positive integer larger than 1. The processor is used for respectfully and continuously outputting corresponding N control signals and N address signals to the N arbiters. After receiving the corresponding control signals, the N arbiters respectfully output the corresponding address signals to corresponding sub-memories, such that the N sub-memories simultaneously access data respectfully according to the N address signals.

According to a second aspect of the present invention, a reading method of memory architecture of display device is provided. The memory architecture includes a display data memory block and a processor. The display data memory block includes N sub-memories and N arbiters, wherein N is a positive integer larger than 1. The reading method includes the following steps. The processor respectfully and continuously outputs corresponding N control signals and N address signals to the N arbiters. After receiving the corresponding control signals, the N arbiters respectfully output the corresponding address signals to corresponding sub-memories, such that the N sub-memories simultaneously access data respectfully according to the N address signals.

The invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of a conventional display device;

FIG. 2 shows a signal clock diagram of a conventional display device;

FIG. 3 shows a block diagram of a display device according to a preferred embodiment of the invention;

FIG. 4 shows a signal clock diagram of a processor according to a preferred embodiment of the invention;

FIG. 5A and FIG. 5B show signal clock diagrams of an arbiter according to a preferred embodiment of the invention; and

FIG. 6 shows a signal clock diagram of a sub-memory according to a preferred embodiment of the invention.

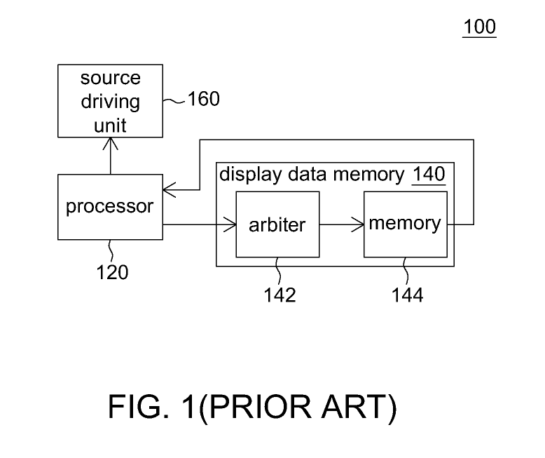

### DETAILED DESCRIPTION OF THE INVENTION

The invention provides a memory architecture of a display device and a reading method thereof. An architecture using multiple arbiters is further accompanied by multi-item pixel accessing method, such that the memory data can be read at a high speed and the power consumption of the overall system is reduced.

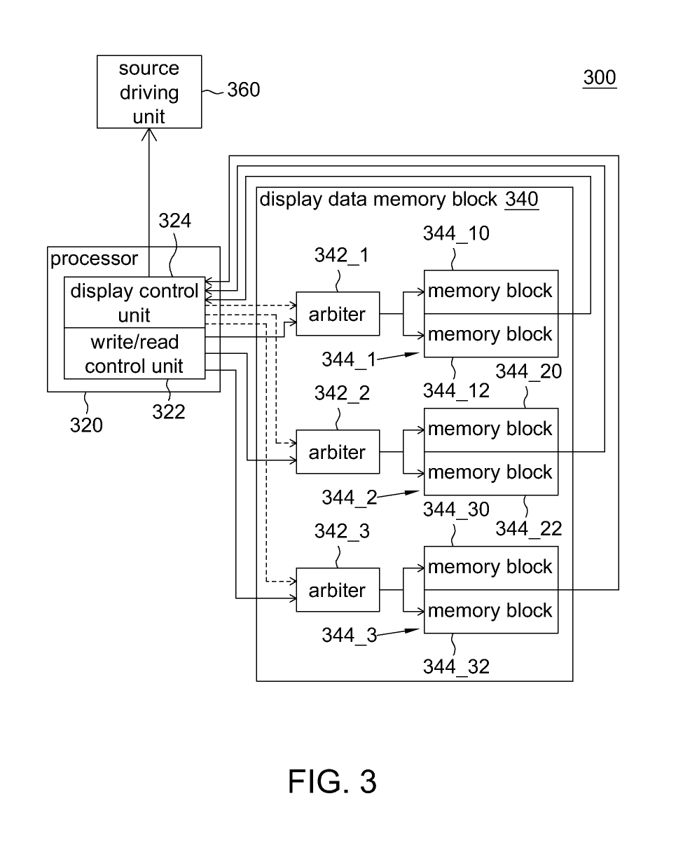

Referring to FIG. 3, a block diagram of a display device according to a preferred embodiment of the invention is shown. The display device 300 includes a processor 320, a display data memory block 340 and a source driving unit 360. The display data memory block 340 includes N sub-memories and N arbiters respectfully coupled to the N sub-memories, wherein N is a positive integer larger than 1. The processor 320 respectfully and continuously outputs corresponding N control signals and N address signals to the N arbiters. After receiving the corresponding control signals, the N arbiters respectfully output the corresponding address signals to corresponding sub-memories, such that the N sub-memories simultaneously access data respectfully according to the N address signals. In FIG. 3, N is exemplified by 3, that is, the display data memory block 340 includes three sub-memories 344_1˜344_3 and three arbiters 342_1˜342_3, but is not limited thereto.

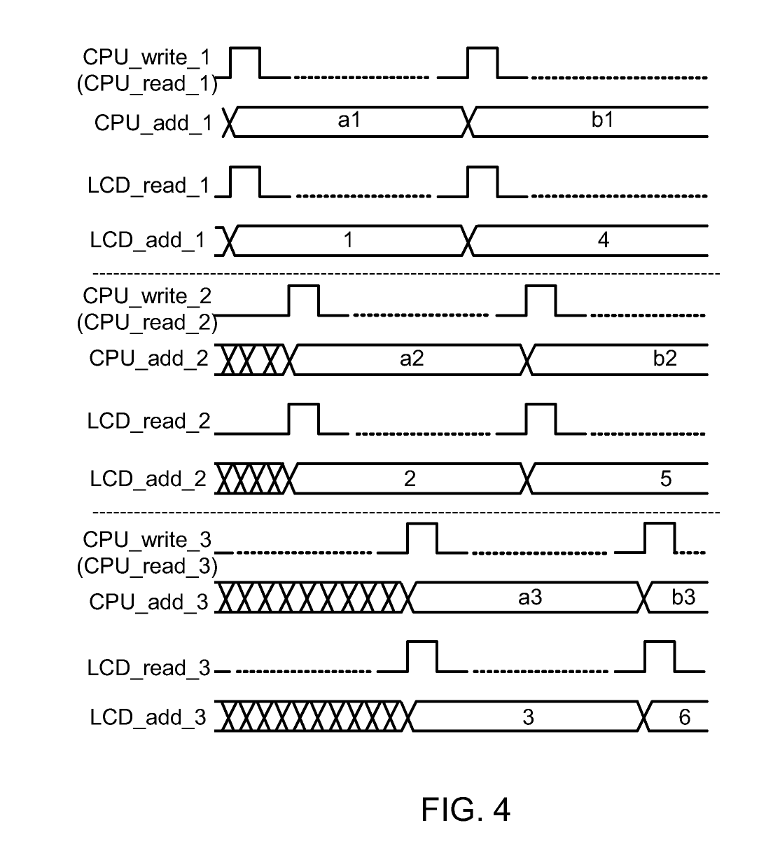

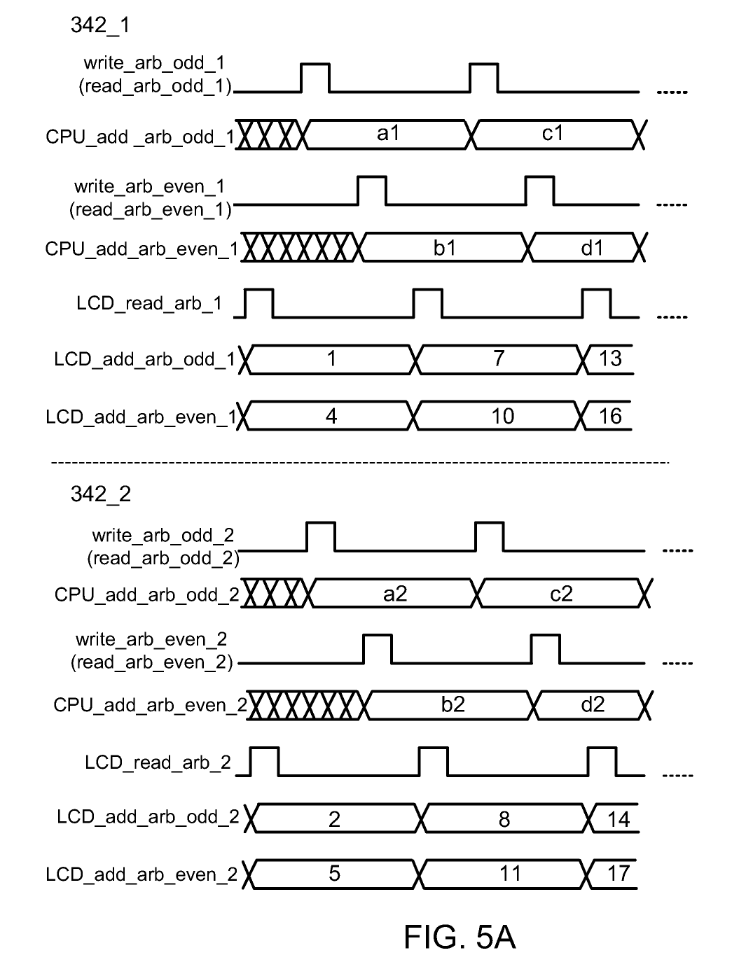

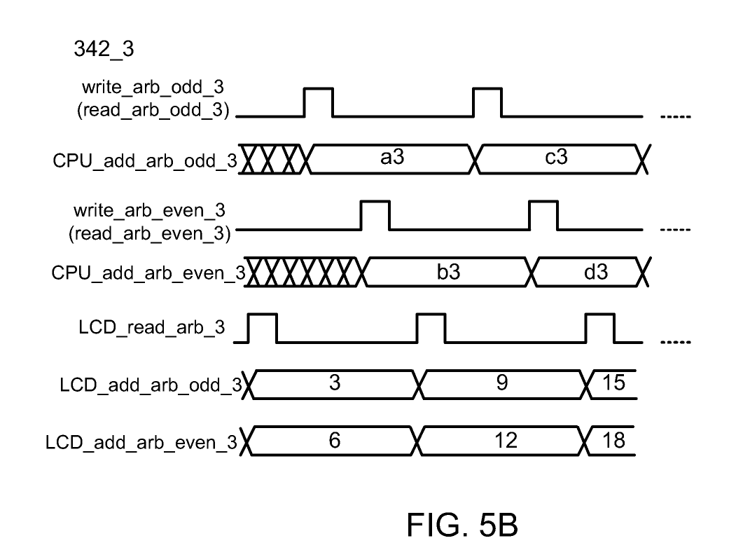

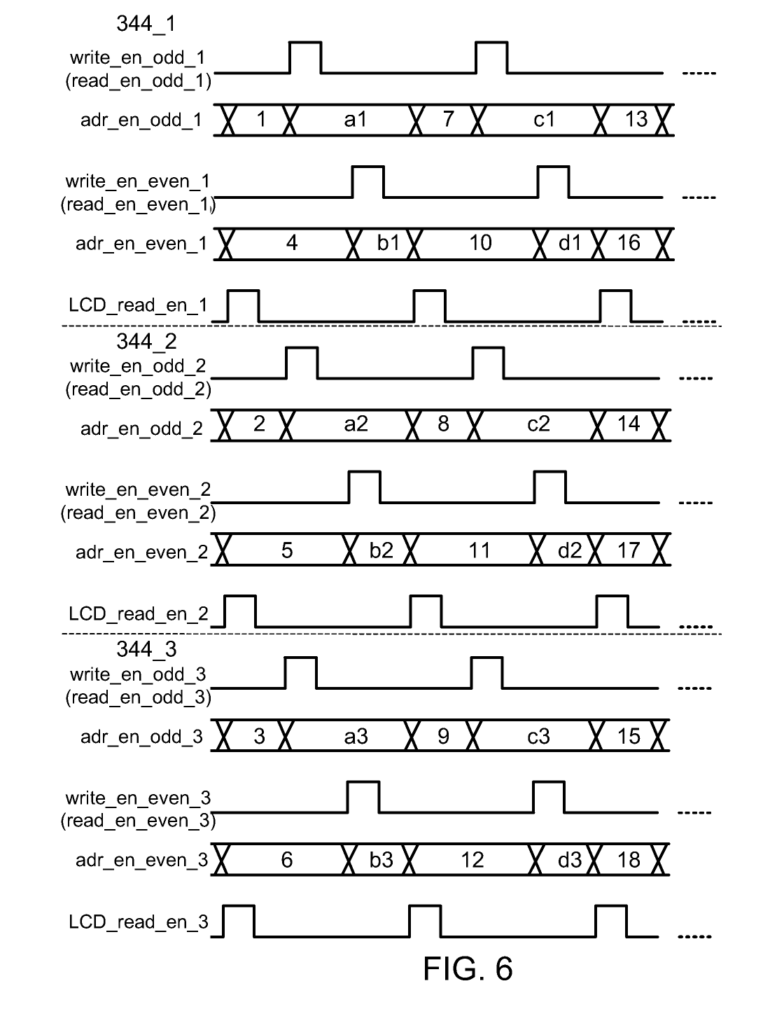

Referring to FIG. 4˜FIG. 6. FIG. 4 shows a signal clock diagram of a processor according to a preferred embodiment of the invention. FIG. 5A and FIG. 5B show signal clock diagrams of an arbiter according to a preferred embodiment of the invention. FIG. 6 shows a signal clock diagram of a sub-memory according to a preferred embodiment of the invention. The processor 320 includes a write/read control unit 322 and a display control unit 324. In order to write pixel data to the display data memory block 340, the control signal and the address signal that are both outputted from the processor 320 are respectfully a data writing signal and an address writing signal. The write/read control unit 322 respectfully and continuously outputs three data writing signals CPU_write_1˜CPU_write_3 and three corresponding address writing signals CPU_add_1˜CPU_add_3 to the arbiters 342_1˜342_3.

In the present embodiment of the invention, each sub-memory is divided into two memory blocks for respectfully storing the data corresponding to an odd-numbered address and the data corresponding to an even-numbered address, but is not limited thereto. For example, the arbiter 342_1, according to the received address writing signal CPU_add_1, divides the address writing signal CPU_add_1 and the corresponding data writing signal CPU_write_1 into a sub-address writing signal CPU_add_arb_odd_1 and a sub-data writing signal write_arb_odd_1 that are both corresponding to an odd-numbered address, and a sub-address writing signal CPU_add_arb_even_1 and a sub-data writing signal write_arb_even_1 that are both corresponding to an even-numbered address. The arbiter 342_1 outputs the sub-address writing signal CPU_add_arb_odd_1 and the sub-data writing signal write_arb_odd_1 to the memory block 344_10 corresponding to an odd-numbered address, and outputs the sub-address writing signal CPU_add_arb_even_1 and the sub-data writing signal write_arb_even_1 to the memory block 344_12 corresponding to an even-numbered address.

Likewise, the arbiter 342_2 outputs the sub-address writing signal CPU_add_arb_odd_2 and the sub-data writing signal write_arb_odd_2 to the memory block 344_20 corresponding to an odd-numbered address, and outputs the sub-address writing signal CPU_add_arb_even_2 and the sub-data writing signal write_arb_even_2 to the memory block 344_22 corresponding to an even-numbered address. The arbiter 342_3 outputs the sub-address writing signal CPU_add_arb_odd_3 and the sub-data writing signal write_arb_odd_3 to the memory block 344_30 corresponding to an odd-numbered address, and outputs the sub-address writing signal CPU_add_arb_even_3 and the sub-data writing signal write_arb_even_3 to the memory blocks 344_32 corresponding to an even-numbered address.

In order to read pixel data from the display data memory block 340, the control signal and the address signal that are both outputted from the processor 320 are respectfully a data reading signal and an address reading signal. The write/read control unit 322 respectfully and continuously outputs three data reading signals CPU_read_1˜CPU_read_3 and three corresponding address reading signals CPU_add_1˜CPU_add_3 to the arbiter 342_1˜342_3. The arbiter 342_1, according to the received address reading signal CPU_add_1, divides the address reading signal CPU_add_1 and the corresponding data reading signal CPU_read_1 into a sub-address reading signal CPU_add_arb_odd_1 and a sub-data reading signal read_arb_odd_1 that are both corresponding to an odd-numbered address, and a sub-address reading signal CPU_add_arb_even_1 and a sub-data reading signal read_arb_even_1 that are both corresponding to an even-numbered address.

The arbiter 342_1 outputs the sub-address reading signal CPU_add_arb_odd_1 and the sub-data reading signal read_arb_odd_1 to the memory blocks 344_10 corresponding to an odd-numbered address, and outputs the sub-address reading signal CPU_add_arb_even_1 and the sub-data reading signal read_arb_even_1 to the memory blocks 344_12 corresponding to an even-numbered address. Likewise, the arbiter 342_2 outputs the sub-address reading signal CPU_add_arb_odd_2 and the sub-data reading signal read_arb_odd_2 to the memory block 344_20 corresponding to an odd-numbered address, and outputs the sub-address reading signal CPU_add_arb_even_2 and the sub-data reading signal read_arb_even_2 to the memory block 344_22 corresponding to an even-numbered address. The arbiter 342_3 outputs the sub-address reading signal CPU_add_arb_odd_3 and the sub-data reading signal read_arb_odd_3 to the memory block 344_30 corresponding to an odd-numbered address, and outputs the sub-address reading signal CPU_add_arb_even_3 and the sub-data reading signal read_arb_even_3 to the memory block 344_32 corresponding to an even-numbered address.

To display a frame on the display device 300, the control signal and the address signal that are both outputted from the processor 320 are respectfully a display reading signal and a display address signal. The display control unit 324 respectfully and continuously outputs three display reading signals LCD_read_1˜LCD_read_3 and three corresponding display address signals LCD_add_1˜LCD_add_3 to the three arbiters 342_1˜342_3. The arbiter 342_1 divides the received display address signal LCD_add_1 into a sub-display address signal LCD_add_arb_odd_1 corresponding to odd-numbered address, and a sub-display address signal LCD_add_arb_even_1 corresponding to even-numbered address.

The arbiter 342_1 outputs the sub-display address signal LCD_add_arb_odd_1 and the display reading signal LCD_read_arb_1 to the memory block 344_10 corresponding to an odd-numbered address, and outputs the sub-display address signal LCD_add_arb_even_1 and the display reading signal LCD_read_arb_1 to the memory block 344_12 corresponding to an even-numbered address. Likewise, the arbiter 342_2 outputs the sub-display address signal LCD_add_arb_odd_2 and the display reading signal LCD_read_arb_2 to the memory block 344_20 corresponding to an odd-numbered address, and outputs the sub-display address signal LCD_add_arb_even_2 and the display reading signal LCD_read_arb_2 to the memory block 344_22 corresponding to an even-numbered address. The arbiter 342_3 outputs the sub-display address signal LCD_add_arb_odd_3 and the display reading signal LCD_read_arb_3 to the memory block 344_30 corresponding to an odd-numbered address, and outputs the sub-display address signal LCD_add_arb_even_3 and the display reading signal LCD_read_arb_3 to the memory block 344_3 corresponding to an even-numbered address.

As indicated in FIG. 6, memory blocks 344_10, according to the write enabling signal write_en_odd_1 corresponding to the sub-data writing signal write_arb_odd_1, the display read enabling signal LCD_read_en_1, the sub-address writing signal CPU_add_arb_even_1 and the sub-display address signal LCD_add_arb_odd_1, obtains an address enabling signal add_en_odd_1, and accordingly outputs data to the processor 320. Likewise, the memory block 344_12, according to the write enabling signal write_en_even_1 corresponding to the sub-data writing signal write_arb_even_1, the display read enabling signal LCD_read_en_1, the sub-address writing signal CPU_add_arb_even_1 and the sub-display address signal LCD_add_arb_even_1, obtains an address enabling signal add_en_even_1, and accordingly outputs data to the processor 320. That is, the sub-memory 344_1 outputs data to the processor 320 in every two items of pixel data (odd/even numbered pixels). The processor 320 outputs display data to the source driving unit 360 for displaying a frame on the display device 300. Examples of the source driving unit 360 include circuits such as shift register and level shifter.

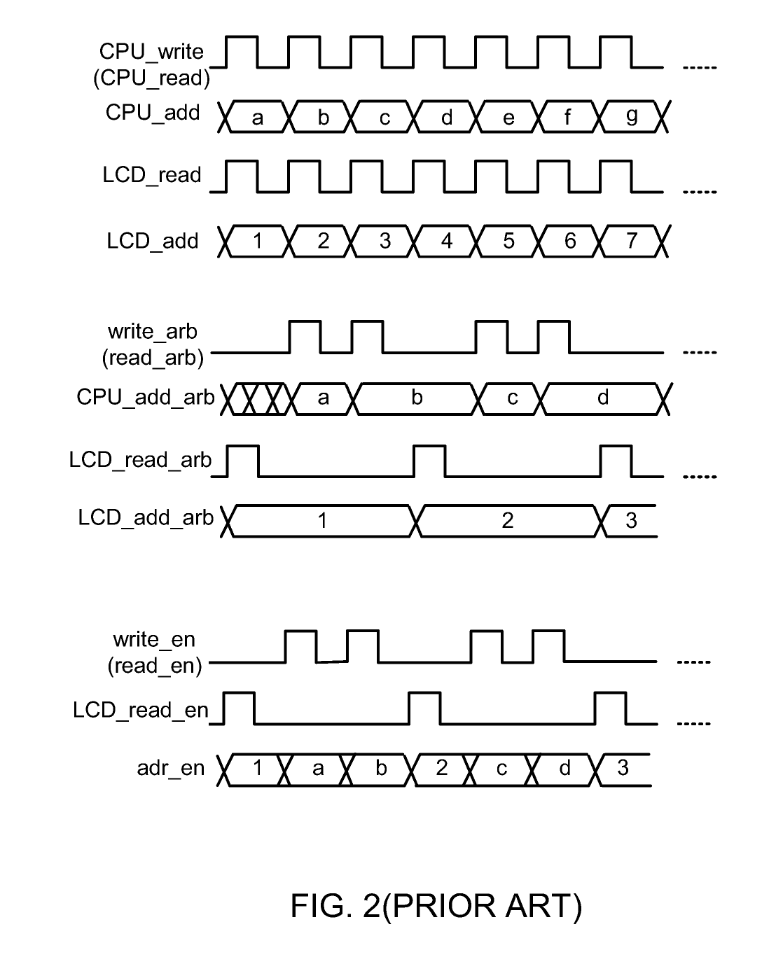

Likewise, the sub-memory 344_2˜344_3 also outputs data to the processor 320 in every two items of pixel data. According to the comparison of FIG. 2 and FIG. 6, within a single a cycle, the data read/written to the sub-memory 344_1˜344_3 is far larger than a data item of the memory 144, and the memory architecture of a display device disclosed in the invention provides a high-speed accessing rate faster than the conventional memory architecture.

Besides, the invention also discloses a reading method of a memory architecture of a display device. The memory architecture includes a display data memory block and a processor. The display data memory block includes N sub-memories and N arbiters. The reading method includes the following steps. The processor respectfully and continuously outputs corresponding N control signals and N address signals to the N arbiters. After receiving the corresponding control signals, the N arbiters respectfully output the corresponding address signals to corresponding sub-memories, such that the N sub-memories simultaneously access data respectfully according to the N address signals. Each sub-memory can be divided into M memory blocks.

The principles of operation of the memory architecture of a display device and the reading method thereof of the invention are disclosed in the elaboration of the display device 300, and are not repeated here.

The memory architecture of a display device and the reading method thereof of the invention disclosed in the above embodiments of the invention have many advantages exemplified below:

According to the memory architecture of a display device and the reading method thereof of the invention, an architecture using multiple arbiters is further accompanied by multi-item pixel accessing method for accessing data from the display data memory of the display device. As the display data memory block of the invention adopts N arbiters, the cycle of the control signal and the address signal that are outputted from the processor is merely 1/N of the original cycle, such that the base frequency of the overall system is reduced, and data can be read/write at a high speed.

Besides, each sub-memory of the invention is divided into M memory blocks according to the address. Thus, the data of the memory blocks can be simultaneously accessed in multi-items of pixel data, such that the data reading rate can be increased to be M times of the original rate. As the display data memory block includes many memory blocks, the length of data routing can be further reduced so as to decrease power consumption of the overall system.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A memory architecture of a display device, comprising:
a display data memory block having N sub-memories and N arbiters respectfully coupled to the N sub-memories, wherein N is a positive integer larger than 1; and
a processor used for respectfully and continuously outputting corresponding N control signals and N address signals to the N arbiters;
wherein, after receiving the corresponding control signals, the N arbiters respectfully output the corresponding address signals to corresponding sub-memories, such that the N sub-memories respectfully simultaneously access data according to the N address signals.

2. The memory architecture of a display device according to claim 1, wherein the control signals are N data writing signals, the address signals are N address writing signals, and after respectfully receiving the N data writing signals, the N arbiters enable the N sub-memories to simultaneously write data respectfully according to the N address writing signals.

3. The memory architecture of a display device according to claim 2, wherein each sub-memory comprises M memory blocks, M is a positive integer larger than 1, each arbiter, according to the received address writing signal, divides the address writing signal and the corresponding data writing signal into M sub-address writing signals and M sub-data writing signals and respectfully outputs the M sub-address writing signals and the M sub-data writing signals to the M memory blocks, such that the M memory blocks respectfully perform data writing according to the M sub-address writing signals.

4. The memory architecture of a display device according to claim 1, wherein the control signals are N data reading signals, the address signals are N address reading signals, and after respectfully receiving the N data reading signals, the N arbiters enable the N sub-memories to simultaneously perform data reading respectfully according to the N address reading signals.

5. The memory architecture of a display device according to claim 4, wherein each sub-memory comprises M memory blocks, M is a positive integer larger than 1, each arbiter, according to the received address reading signal, divides the address reading signal and the corresponding data reading signal into M sub-address reading signals and M sub-data reading signals and respectfully outputs the M sub-address reading signals and the M sub-data reading signals to the M memory blocks, such that the M memory blocks respectfully perform data reading according to the M sub-address reading signals.

6. The memory architecture of a display device according to claim 1, wherein the control signals are N display reading signals, the address signals are N display address signals, and after respectfully receiving the N display reading signals, and the N arbiters enable the N sub-memories to simultaneously read the corresponding display data respectfully according to the N display address signals and output the corresponding display data to the processor, which receives these display data and further outputs these display data to a source driving unit of the display device.

7. The memory architecture of a display device according to claim 6, wherein each sub-memory comprises M memory blocks, M is a positive integer larger than 1, each arbiter, according to the received display address signal, divides the display address signal into M sub-the display address signals and respectfully outputs the M sub-the display address signals to the M memory blocks, such that the M memory blocks simultaneously read the corresponding display data respectfully according to the M sub-the display address signals and further outputs the corresponding display data to the processor.

8. A reading method of memory architecture of display device, wherein the memory architecture comprises a display data memory block and a processor, the display data memory block comprises N sub-memories and N arbiters, N is a positive integer larger than 1, and the reading method comprises:
respectfully and continuously outputting corresponding N control signals and N address signals to the N arbiters by the processor; and
respectfully outputting the corresponding address signals to corresponding sub-memories by the N arbiters after receiving the corresponding control signals, such that the N sub-memories respectfully and simultaneously access data according to the N address signals.

9. The reading method according to claim 8, wherein the control signals are N data writing signals, the address signals are N address writing signals, and the reading method further comprises:
enabling the N sub-memories to simultaneously perform data writing respectfully according to the N address writing signals by the N arbiters after respectfully receiving the N data writing signals.

10. The reading method according to claim 9, wherein each sub-memory comprises M memory blocks, M is a positive integer larger than 1, and the reading method further comprises:
each arbiter for dividing the address writing signal and the corresponding data writing signal into M sub-address writing signals and M sub-data writing signals according to the received address writing signal, and further respectfully outputting the M sub-address writing signals and the M sub-data writing signals to the M memory blocks; and
performing data writing by the M memory blocks respectfully according to the M sub-address writing signals.

11. The reading method according to claim 8, wherein the control signals are N data reading signals, the address signals are N address reading signals, and the reading method further comprises:
enabling the N sub-memories respectfully to simultaneously perform data reading according to the N address reading signals by the N arbiters after respectfully receiving the N data reading signals.

12. The reading method according to claim 11, wherein each sub-memory comprises M memory blocks, M is a positive integer larger than 1, and the reading method further comprises:
each arbiter for dividing the address reading signal and the corresponding data reading signal into M sub-address reading signals and M sub-data reading signals according to the received address reading signal and respectfully outputting the M sub-address reading signals and the M sub-data reading signals to the M memory blocks; and
performing data reading by the M memory blocks respectfully according to the M sub-address reading signals.

13. The reading method according to claim 8, wherein the control signals are N display reading signals, the address signals are N display address signals, the reading method further comprises:
enabling the N sub-memories to simultaneously read corresponding display data respectfully by the N arbiters after respectfully receiving the N display reading signals according to the N display address signals and further output the corresponding display data to the processor by the N arbiters; and
receiving these display data and further outputting these display data to a source driving unit of the display device by the processor.

14. The reading method according to claim 13, wherein each sub-memory comprises M memory blocks, M is a positive integer larger than 1, and the reading method further comprises:
each arbiter for dividing the display address signal into M sub-the display address signals according to the received display address signal and respectfully outputting the M sub-the display address signals to the M memory blocks; and
simultaneously reading the corresponding display data respectfully by the M memory blocks according to the M sub-the display address signals and further outputting the corresponding display data to the processor by the M memory blocks.
